(19) United States
(12) Patent Application Publication
(10) Pub. No.: US 2026/0178886 A1
(43) Pub. Date: Jun. 25, 2026

(54) SYSTEM AND METHOD FOR MODELING AND TRAINING A DEEP GENERATIVE MODEL FOR TIME SERIES WITH CHANGE POINTS

(71) Applicant: JPMorgan Chase Bank, N.A., New York, NY (US)

(72) Inventors: Yousef EL-LAHAM, Brooklyn, NY (US); Zhongchang SUN, Redmond, WA (US); Svitlana VYETRENKO, Berkeley, CA (US)

(73) Assignee: JPMorgan Chase Bank, N.A., New York, NY (US)

(21) Appl. No.: 18/987,337

(22) Filed: Dec. 19, 2024

(51) Int. Cl. G06N 3/047; G06N 3/0475; G06N 3/0895

(52) U.S. Cl. CPC G06N 3/047; G06N 3/0475; G06N 3/0895

(57) ABSTRACT

Various methods and processes, apparatuses/systems, and media for modeling and training a generative model for time series datasets are disclosed. A processor partitions a training data into a plurality of segments based on a sliding window approach; inputs the plurality of segments sequentially into a GAN discriminator that generates a sequence of scores corresponding to the plurality of segments; computes a Wasserstein distance between two consecutive segments; detects change points by specifying corresponding change point with reference to difference of scores between two consecutive segments at which the computed Wasserstein distance between the two consecutive segments is the largest; models the neural SDEs with the detected change points; and trains the neural SDEs by alternating between detecting the change points while holding model parameters of the neural SDEs fixed and optimizing parameters of the GAN while holding the detected change points fixed, thereby improving performance of the generative model.

### TECHNICAL FIELD

This disclosure generally relates to modeling and training a generative model, and, more particularly, to methods and apparatuses for implementing a platform, language, cloud, and database agnostic time series modeling and training module configured to model and train a deep generative model for time series with change points.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Stochastic differential equations (SDEs) are a class of mathematical equations used to model continuous-time stochastic processes, with applications ranging from biology and engineering to physics and finance. Recently, neural SDEs have been proposed as a means to integrate neural networks with SDEs, providing a more flexible approach for modeling sequential data. There appears to be a connection between neural SDEs and generative adversarial networks (GANs), based on a finding that certain classes of neural SDEs may be interpreted as infinite-dimensional GANs. A typical approach may involve a variational autoencoder (VAE) framework for identifying latent SDEs from noisy observations based on the Euler-Maruyama approximation of SDE solutions.

However, existing works on neural SDEs mainly focus on the case where the time series may be modeled by a single SDE. In real-world applications, however, the underlying dynamics of the data may change over time. For example, financial time series may exhibit sharp distributional shifts due to exogenous factors (e.g., global financial crisis, the COVID-19 pandemic). To train the neural SDEs, it is typically common to assume that the drift and diffusion terms are Lipschitz continuous. This assumption may prove to be restrictive, in the sense that a single neural SDE with Lipschitz smooth drift and diffusion may not effectively model time series with sudden distributional shifts.

Change point detection may be a critical aspect of time series analysis, especially in domains such as finance, climate science, and sensor data processing, where abrupt shifts in behavior may have profound implications.

According to one conventional approach, SDEs may be applied to detect change points in time series. However, the drift and diffusion functions in this conventional approach is characterized by a restricted number of parameters instead of neural networks, which constrains the overall model capacity of SDEs, thereby substantially reducing model performance.

In another conventional approach, latent neural SDEs may be introduced to detect changes in time series, where a single SDE in the latent space may be assumed and may be trained using VAEs. In this conventional approach, it may be assumed that there is a prior SDE with a known diffusion term in the latent space for the tractability purposes of the loss function. However, this assumption may prove to be too restrictive since the training data might not necessarily conform to this latent SDE, thereby substantially reducing model performance.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic time series modeling and training module configured to model and train a deep generative model for time series with change points using GAN-based neural SDEs, thereby substantially improving performance of the deep generative model, but the disclosure is not limited thereto. By identifying change points, the time series modeling and training module disclosed herein may be configured to partition the time series into distinct segments where each segment is described by a different SDE model. This adaptation allows the time series modeling and training module to capture the specific characteristics and uncertainties within each segment, leading to a more precise understanding of the underlying processes and improved performance of the generative model.

In some embodiments, a method for a modeling and training a generative model for time series datasets by utilizing one or more processors along with allocated memory is disclosed. The method may include: identifying the time series datasets, accessed from a database by calling an application programming interface, as training data to be utilized to model and train the generative model as neural stochastic differential equations (SDEs); partitioning the training data into a plurality of segments based on a sliding window approach; inputting the plurality of segments sequentially into a generative adversarial network (GAN) discriminator thereby transforming the GAN discriminator into a learned GAN discriminator; generating, by utilizing the learned GAN discriminator, a sequence of scores corresponding to the plurality of segments; computing, by utilizing the learned GAN discriminator, a Wasserstein distance between two consecutive segments among the plurality of segments; detecting change points based on output of the learned GAN discriminator by specifying corresponding change point with reference to difference of scores between two consecutive segments at which the computed Wasserstein distance between the two consecutive segments is the largest; modeling the neural SDEs with the detected change points; and training the neural SDEs by alternating between detecting the change points while holding model parameters of the neural SDEs fixed and generating parameters of the GAN while holding the detected change points fixed thereby improving performance of the generative model.

In some embodiments according to the method, the time series datasets may include both synthetic datasets and real-world datasets.

In some embodiments, the method may further include: defining an average mean of each segment among the plurality of segments over all training samples of the time series datasets; and detecting the change points utilizing the average mean.

In some embodiments, the method may further include: defining a maximum mean discrepancy based on quantifying the difference of scores between two consecutive segments among the plurality of segments; and detecting the change points utilizing the maximum mean discrepancy.

In some embodiments according to the method, the SDEs may be a class of mathematical equations utilized for modeling continuous-time stochastic processes.

In some embodiments according to the method, each SDE may be composed of two components: a drift function and a diffusion function. The drift function may indicate how a trend of the time series datasets evolve with time, and the diffusion function may indicate how a stochasticity or a variation of the time series datasets evolve with time, but the disclosure is not limited thereto.

In some embodiments, in detecting the change points, the method may further include: implementing an algorithm that iteratively computes a statistic on the difference of scores between the two consecutive segments in the time series datasets, wherein a relatively large changes in the statistic beyond a configurable threshold value indicates a change point.

In some embodiments, a system for a modeling and training a generative model for time series datasets is disclosed. The system may include: a processor; and a memory operatively connected to the processor via a communication interface, the memory storing computer readable instructions, when executed, may cause the processor to: identify the time series datasets, accessed from a database by calling an application programming interface, as training data to be utilized to model and train the generative model as neural SDEs; partition the training data into a plurality of segments based on a sliding window approach; input the plurality of segments sequentially into a GAN discriminator thereby transforming the GAN discriminator into a learned GAN discriminator; generate, by utilizing the learned GAN discriminator, a sequence of scores corresponding to the plurality of segments; compute, by utilizing the learned GAN discriminator, a Wasserstein distance between two consecutive segments among the plurality of segments; detect change points based on output of the learned GAN discriminator by specifying corresponding change point with reference to difference of scores between two consecutive segments at which the computed Wasserstein distance between the two consecutive segments is the largest; model the neural SDEs with the detected change points; and train the neural SDEs by alternating between detecting the change points while holding model parameters of the neural SDEs fixed and generate parameters of the GAN while holding the detected change points fixed thereby improving performance of the generative model.

In some embodiments according to the system, the time series datasets may include both synthetic datasets and real-world datasets.

In some embodiments, the processor may be further configured to: define an average mean of each segment among the plurality of segments over all training samples of the time series datasets; and detect the change points utilizing the average mean.

In some embodiments, the processor may be further configured to: define a maximum mean discrepancy based on quantifying the difference of scores between two consecutive segments among the plurality of segments; and detect the change points utilizing the maximum mean discrepancy.

In some embodiments according to the system, the SDEs may be a class of mathematical equations utilized for modeling continuous-time stochastic processes.

In some embodiments according to the system, each SDE may be composed of two components: a drift function and a diffusion function. The drift function may indicate how a trend of the time series datasets evolve with time, and the diffusion function may indicate how a stochasticity or a variation of the time series datasets evolve with time, but the disclosure is not limited thereto.

In some embodiments, in detecting the change points, the processor may be further configured to: implement an algorithm that iteratively computes a statistic on the difference of scores between the two consecutive segments in the time series datasets, wherein a relatively large changes in the statistic beyond a configurable threshold value indicates a change point.

In some embodiments, a non-transitory computer readable medium configured to store instructions for modeling and training a generative model for time series datasets is disclosed. The instructions, when executed, may cause a processor to perform the following: identifying the time series datasets, accessed from a database by calling an application programming interface, as training data to be utilized to model and train the generative model as neural SDEs; partitioning the training data into a plurality of segments based on a sliding window approach; inputting the plurality of segments sequentially into a GAN discriminator thereby transforming the GAN discriminator into a learned GAN discriminator; generating, by utilizing the learned GAN discriminator, a sequence of scores corresponding to the plurality of segments; computing, by utilizing the learned GAN discriminator, a Wasserstein distance between two consecutive segments among the plurality of segments; detecting change points based on output of the learned GAN discriminator by specifying corresponding change point with reference to difference of scores between two consecutive segments at which the computed Wasserstein distance between the two consecutive segments is the largest; modeling the neural SDEs with the detected change points; and training the neural SDEs by alternating between detecting the change points while holding model parameters of the neural SDEs fixed and generating parameters of the GAN while holding the detected change points fixed thereby improving performance of the generative model.

In some embodiments according to the non-transitory computer readable medium, the time series datasets may include both synthetic datasets and real-world datasets.

In some embodiments, the instructions, when executed, may cause the processor to further perform the following: defining an average mean of each segment among the plurality of segments over all training samples of the time series datasets; and detecting the change points utilizing the average mean.

In some embodiments, the instructions, when executed, may cause the processor to further perform the following: defining a maximum mean discrepancy based on quantifying the difference of scores between two consecutive segments among the plurality of segments; and detecting the change points utilizing the maximum mean discrepancy.

In some embodiments according to the non-transitory computer readable medium, the SDEs may be a class of mathematical equations utilized for modeling continuous-time stochastic processes.

In some embodiments according to the non-transitory computer readable medium, each SDE may be composed of two components: a drift function and a diffusion function. The drift function may indicate how a trend of the time series datasets evolve with time, and the diffusion function may indicate how a stochasticity or a variation of the time series datasets evolve with time, but the disclosure is not limited thereto.

In some embodiments, in detecting the change points, the instructions, when executed, may cause the processor to further perform the following: implementing an algorithm that iteratively computes a statistic on the difference of scores between the two consecutive segments in the time series datasets, wherein a relatively large changes in the statistic beyond a configurable threshold value indicates a change point.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic time series modeling and training module configured to model and train a deep generative model for time series with change points, thereby substantially improving performance of the deep generative model in accordance with an embodiment.

FIG. 2 illustrates a diagram of a network environment with a platform, language, database, and cloud agnostic time series modeling and training device in accordance with an embodiment.

FIG. 3 illustrates a system diagram for implementing a platform, language, database, and cloud agnostic time series modeling and training device having a platform, language, database, and cloud agnostic time series modeling and training module in accordance with an embodiment.

FIG. 4 illustrates a system diagram for implementing a platform, language, database, and cloud agnostic time series modeling and training module of FIG. 3 in accordance with an embodiment.

FIG. 5 illustrates an algorithm implemented by the platform, language, database, and cloud agnostic time series modeling and training module of FIG. 4 for modeling and training a deep generative model for time series with change points in accordance with an embodiment.

FIG. 6 illustrates a flow chart of a process implemented by the platform, language, database, and cloud agnostic time series modeling and training module of FIG. 4 for modeling and training a deep generative model for time series with change points in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, a typical approach in training the neural SDEs may involve a VAE framework for identifying latent SDEs from noisy observations based on the Euler-Maruyama approximation of SDE solutions. However, existing works on neural SDEs mainly focus on the case where the time series is modeled by a single SDE. In real-world applications, however, the underlying dynamics of the data may change over time. For example, financial time series may exhibit sharp distributional shifts due to exogenous factors (e.g., global financial crisis, the COVID-19 pandemic). To train the neural SDEs, it is typically common to assume that the drift and diffusion terms are Lipschitz continuous. This assumption may prove to be restrictive, in the sense that a single neural SDE with Lipschitz smooth drift and diffusion may not effectively model time series with sudden distributional shifts. This motivates the inventors of the instant application to study the change point detection problem of SDEs and model the time series as multiple SDEs conditioned on the change points.

According to one conventional approach, SDEs may be applied to detect change points in time series. However, the drift and diffusion functions in this conventional approach is characterized by a restricted number of parameters instead of neural networks, which constrains the overall model capacity of SDEs, thereby substantially reducing model performance. In another conventional approach, latent neural SDEs are introduced to detect changes in time series, where a single SDE in the latent space is assumed and is trained using VAEs. In this conventional approach, it is assumed that there is a prior SDE with a known diffusion term in the latent space for the tractability purposes of the loss function. However, this assumption may prove to be too restrictive since the training data might not necessarily conform to this latent SDE, thereby substantially reducing model performance.

The present disclosure, through one or more of its various aspects, embodiments, and/or specific features or sub-components, provides, among other features, various systems, servers, devices, methods, media, programs, and platforms for implementing a platform, language, cloud, and database agnostic time series modeling and training module configured to model and train a deep generative model for time series with change points using GAN-based neural SDEs, thereby substantially improving performance of the deep generative model and accuracy of model output, but the disclosure is not limited thereto. By identifying change points, the time series modeling and training module disclosed herein may be configured to partition the time series into distinct segments where each segment is described by a different SDE model. This adaptation allows the time series modeling and training module to capture the specific characteristics and uncertainties within each segment, leading to a more precise understanding of the underlying processes and improved performance of the generative model and greatly improved accuracy of model output, but the disclosure is not limited thereto.

While many of the exemplary embodiments discussed herein focus on applications in the financial markets, it should be understood that the technology described herein may be applied to a wide variety of other application domains, such as biology, physics, and engineering.

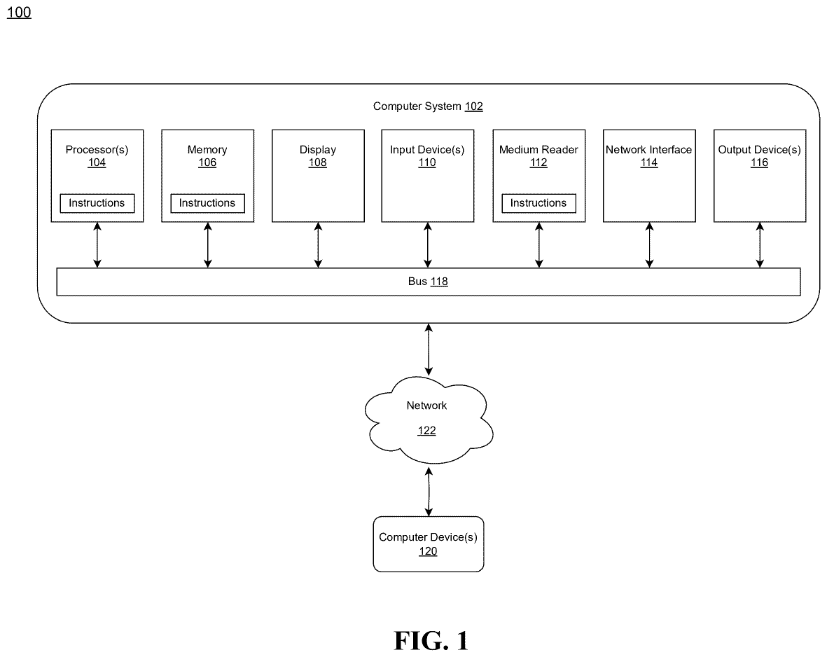

FIG. 1 is an exemplary system 100 for use in implementing a platform, language, database, and cloud agnostic time series modeling and training module configured to model and train a deep generative model for time series with change points using GAN-based neural SDEs, thereby substantially improving performance of the deep generative model in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the time series modeling and training module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the time series modeling and training module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

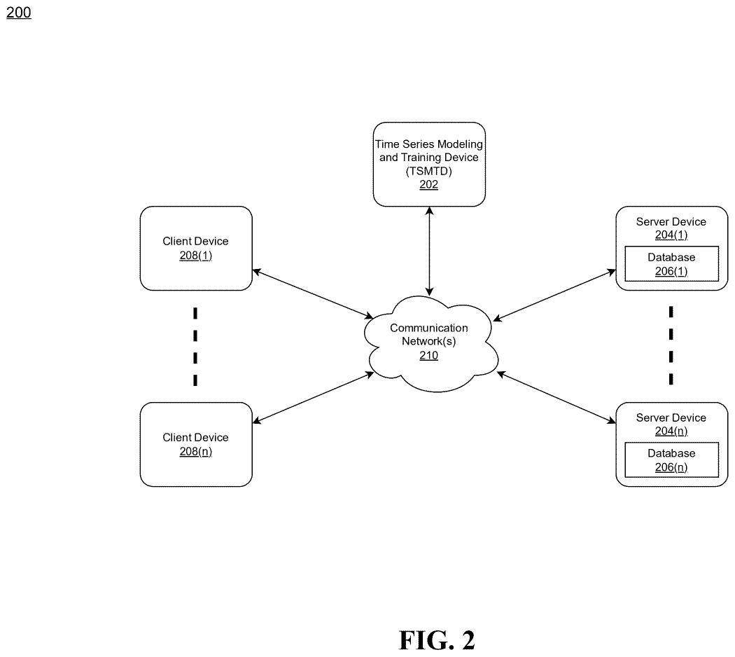

Referring to FIG. 2, a schematic of an exemplary network environment 200 for implementing a language, platform, database, and cloud agnostic time series modeling and training device (TSMTD) of the instant disclosure is illustrated.

In some embodiments, the above-described problems associated with conventional tools may be overcome by implementing an TSMTD 202 as illustrated in FIG. 2 that may be configured for implementing a platform, language, database, and cloud agnostic time series modeling and training module configured to model and train a deep generative model for time series with change points using GAN-based neural SDEs, thereby substantially improving performance of the deep generative model, but the disclosure is not limited thereto. By identifying change points, the TSMTD 202 disclosed herein may be configured to partition the time series into distinct segments where each segment is described by a different SDE model. This adaptation allows the TSMTD 202 to capture the specific characteristics and uncertainties within each segment, leading to a more precise understanding of the underlying processes and improved performance of the generative model, but the disclosure is not limited thereto.

The TSMTD 202 may have one or more computer system 102s, as described with respect to FIG. 1, which in aggregate provide the necessary functions.

The TSMTD 202 may store one or more applications that may include executable instructions that, when executed by the TSMTD 202, cause the TSMTD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the TSMTD 202 itself, may be located in virtual server(s) running in a cloud-based computing environment rather than being tied to one or more specific physical network computing devices. Also, the application(s) may be running in one or more virtual machines (VMs) executing on the TSMTD 202. Additionally, in one or more embodiments of this technology, virtual machine(s) running on the TSMTD 202 may be managed or supervised by a hypervisor.

In the network environment 200 of FIG. 2, the TSMTD 202 may be coupled to a plurality of server devices 204(1)-204(n) that hosts a plurality of databases 206(1)-206(n), and also to a plurality of client devices 208(1)-208(n) via communication network(s) 210. A communication interface of the TSMTD 202, such as the network interface 114 of the computer system 102 of FIG. 1, operatively couples and communicates between the TSMTD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TSMTD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The TSMTD 202 may be a standalone device or integrated with one or more other devices or apparatuses, such as one or more of the server devices 204(1)-204(n). In some embodiments, the TSMTD 202 may be hosted by one of the server devices 204(1)-204(n), and other arrangements may also be possible. Moreover, one or more of the devices of the TSMTD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the TSMTD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the TSMTD 202 that may efficiently provide a platform for implementing a platform, language, database, and cloud agnostic time series modeling and training module configured to model and train a deep generative model for time series with change points using GAN-based neural SDEs, thereby substantially improving performance of the deep generative model, but the disclosure is not limited thereto.

The client devices 208(1)-208(n) may run interface applications, such as standard web browsers or standalone client applications, which may provide an interface to communicate with the TSMTD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the TSMTD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the TSMTD 202, the server devices 204(1)-204(n), or the client devices 208(1)-208(n), in some embodiments, may be configured to operate as virtual instances on the same physical machine. In some embodiments, one or more of the TSMTD 202, the server devices 204(1)-204(n), or the client devices 208(1)-208(n) may operate on the same physical device rather than as separate devices communicating through communication network(s) 210. Additionally, there may be more or fewer TSMTDs 202, server devices 204(1)-204(n), or client devices 208(1)-208(n) than illustrated in FIG. 2. In some embodiments, the TSMTD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

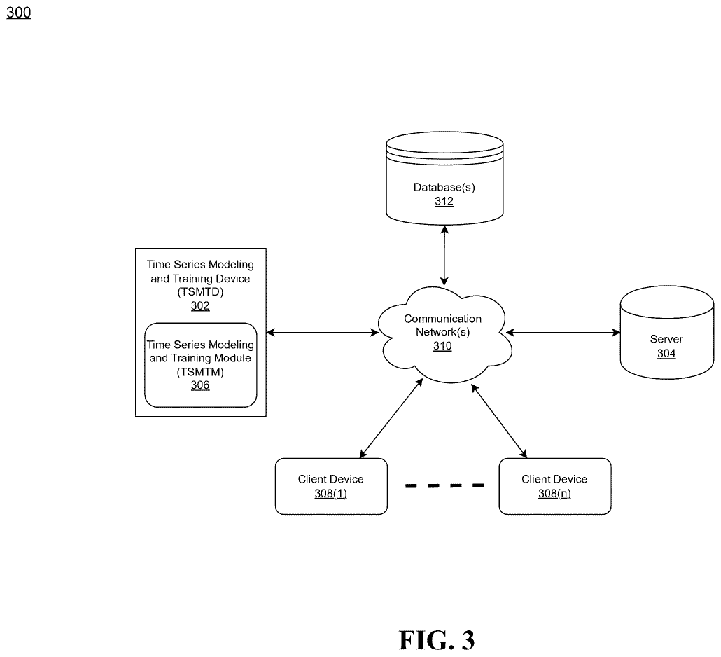

FIG. 3 illustrates a system diagram for implementing a platform, language, and cloud agnostic TSMTD having a platform, language, database, and cloud agnostic time series modeling and training module (TSMTM) in accordance with an embodiment.

As illustrated in FIG. 3, the system 300 may include an TSMTD 302 within which an TSMTM 306 may be embedded, a server 304, a database(s) 312, a plurality of client devices 308(1) . . . 308(n), and a communication network 310.

In some embodiments, the TSMTD 302 including the TSMTM 306 may be connected to the server 304, and the database(s) 312 via the communication network 310. The TSMTD 302 may also be connected to the plurality of client devices 308(1) . . . 308(n) via the communication network 310, but the disclosure is not limited thereto.

According to exemplary embodiment, the TSMTD 302 is described and shown in FIG. 3 as including the TSMTM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the TSMTM 306 may be configured to receive real-time feed of data from the plurality of client devices 308(1) . . . 308(n) and secondary sources via the communication network 310.

As may be described below, the TSMTM 306 may be configured to: identify the time series datasets, accessed from a database by calling an application programming interface, as training data to be utilized to model and train the generative model as neural SDEs; partition the training data into a plurality of segments based on a sliding window approach; input the plurality of segments sequentially into a GAN discriminator thereby transforming the GAN discriminator into a learned GAN discriminator; generate, by utilizing the learned GAN discriminator, a sequence of scores corresponding to the plurality of segments; compute, by utilizing the learned GAN discriminator, a Wasserstein distance between two consecutive segments among the plurality of segments; detect change points based on output of the learned GAN discriminator by specifying corresponding change point with reference to difference of scores between two consecutive segments at which the computed Wasserstein distance between the two consecutive segments is the largest; model the neural SDEs with the detected change points; and train the neural SDEs by alternating between detecting the change points while holding model parameters of the neural SDEs fixed and generate parameters of the GAN while holding the detected change points fixed thereby improving performance of the generative model, but the disclosure is not limited thereto.

The plurality of client devices 308(1) . . . 308(n) are illustrated as being in communication with the TSMTD 302. In this regard, the plurality of client devices 308(1) . . . 308(n) may be “clients” (e.g., customers) of the TSMTD 302 and are described herein as such. Nevertheless, it is to be known and understood that the plurality of client devices 308(1) . . . 308(n) need not necessarily be “clients” of the TSMTD 302, or any entity described in association therewith herein. Any additional or alternative relationship may exist between either or both of the plurality of client devices 308(1) . . . 308(n) and the TSMTD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the TSMTD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The TSMTD 302 may be the same or similar to the TSMTD 202 as described with respect to FIG. 2, including any features or combination of features described with respect thereto.

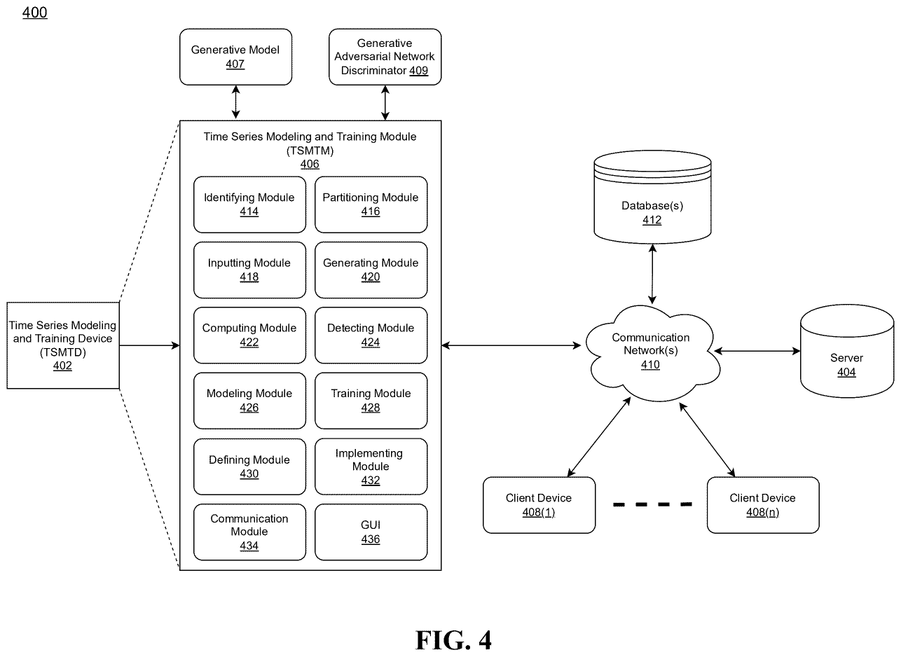

FIG. 4 illustrates a system diagram for implementing a platform, language, database, and cloud agnostic TSMTM of FIG. 3 in accordance with an exemplary embodiment.

In some embodiments, the system 400 may include a platform, language, database, and cloud agnostic TSMTD 402 within which a platform, language, database, and cloud agnostic TSMTM 406 may be embedded, a server 404, a generative model 407, a generative adversarial network (GAN) discriminator 409, database(s) 412, and a communication network 410. In some embodiments, server 404 may comprise a plurality of servers located centrally or located in different locations, but the disclosure is not limited thereto.

In some embodiments, the TSMTD 402 including the TSMTM 406 may be connected to the server 404, the generative model 407, the GAN discriminator 409, and the database(s) 412 via the communication network 410. The TSMTD 402 may also be connected to the plurality of client devices 408(1)-408(n) via the communication network 410, but the disclosure is not limited thereto. The TSMTM 406, the server 404, the plurality of client devices 408(1)-408(n), the database(s) 412, the communication network 410 as illustrated in FIG. 4 may be the same or similar to the TSMTM 306, the server 304, the plurality of client devices 308(1)-308(n), the database(s) 312, the communication network 310, respectively, as illustrated in FIG. 3.

In some embodiments, as illustrated in FIG. 4, the TSMTM 406 may include an identifying module 414, a partitioning module 416, an inputting module 418, a generating module 420, a computing module 422, a detecting module 424, a modeling module 426, a training module 428, a defining module 430, an implementing module 432, a communication module 434, and a Graphical User Interface (GUI) 436. In some embodiments, interactions and data exchange among these modules included in the TSMTM 406 provide the advantageous effects of the disclosed invention. Functionalities of each module of FIG. 4 may be described in detail below with reference to FIGS. 4-6.

In some embodiments, each of the identifying module 414, partitioning module 416, inputting module 418, generating module 420, computing module 422, detecting module 424, modeling module 426, training module 428, defining module 430, implementing module 432, and the communication module 434 of the TSMTM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the identifying module 414, partitioning module 416, inputting module 418, generating module 420, computing module 422, detecting module 424, modeling module 426, training module 428, defining module 430, implementing module 432, and the communication module 434 of the TSMTM 406 of FIG. 4 may be implemented by microprocessors or similar, and may be programmed using software (e.g., microcode) to perform various functions discussed herein and may optionally be driven by firmware and/or software.

Alternatively, in some embodiments, each of identifying module 414, partitioning module 416, inputting module 418, generating module 420, computing module 422, detecting module 424, modeling module 426, training module 428, defining module 430, implementing module 432, and the communication module 434 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the TSMTM 406 of FIG. 4 may also be implemented by cloud-based deployment.

In some embodiments, each of the identifying module 414, partitioning module 416, inputting module 418, generating module 420, computing module 422, detecting module 424, modeling module 426, training module 428, defining module 430, implementing module 432, and the communication module 434 of the TSMTM 406 of FIG. 4 may be called via corresponding API, but the disclosure is not limited thereto. For example, in some embodiments, the identifying module 414 may be called via a first API, the partitioning module 416 may be called via a second API, the inputting module 418 may be called via a third API, the generating module 420 may be called via a fourth API, the computing module 422 may be called via a fifth API, the detecting module 424 may be called via a sixth API, the modeling module 426 may be called via a seventh API, the training module 428 may be called via an eight API, the defining module 430 may be called via a ninth API, the implementing module 432 may be called via a tenth API, and the communication module 430 may be called via an eleventh API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the TSMTM 406 may be executed via the communication module 434, and the communication network 410, which may comprise plural networks as described above. In some embodiments, in an exemplary embodiment, the various components of the TSMTM 406 may communicate with the server 404, the generative model 407, the GAN discriminator 409, and the database(s) 412 via the communication module 434 and the communication network 410 and the results may be displayed onto the GUI 436. Of course, these embodiments are merely exemplary and are not limiting or exhaustive. The database(s) 412 may include the databases included within the private cloud and/or public cloud and the server 404 may include one or more servers within the private cloud and the public cloud.

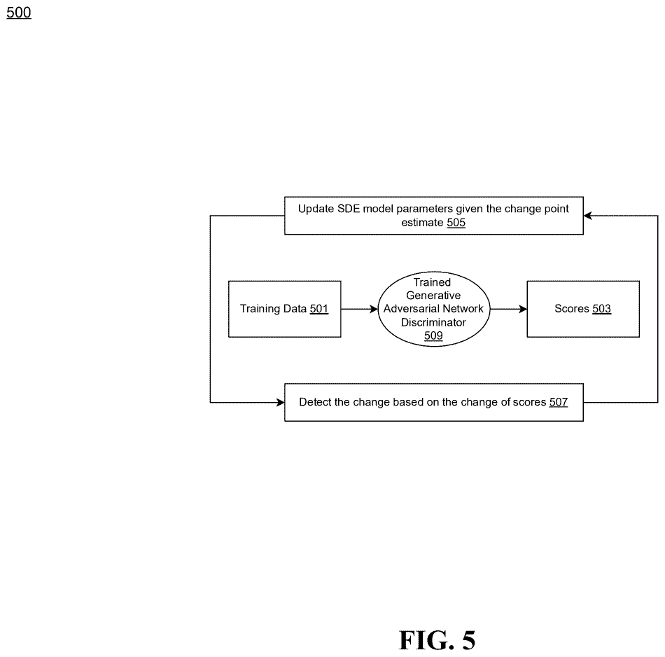

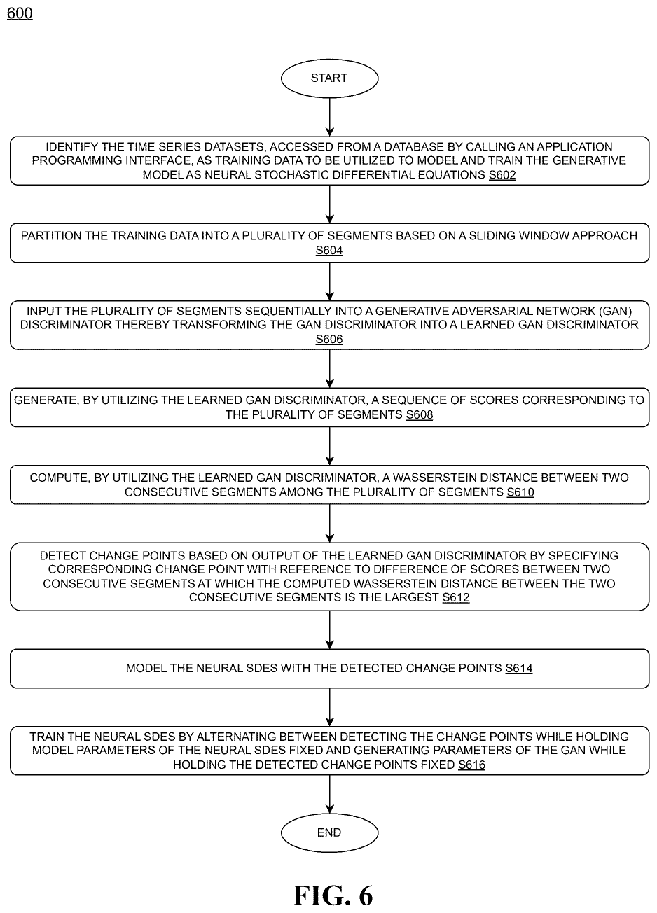

FIG. 5 illustrates an algorithm 500 implemented by the TSMTM 406 of FIG. 4 for modeling and training the deep generative model 407 for time series with change points in accordance with an embodiment. FIG. 6 illustrates a flow chart of a process 600 implemented by the TSMTM 406 of FIG. 4 for modeling and training a deep generative model for time series with change points in accordance with an embodiment. It may be appreciated that the illustrated process 600 and associated steps may be performed in a different order, with illustrated steps omitted, with additional steps added, or with a combination of reordered, combined, omitted, or additional steps.

Referring to FIGS. 4-6, in some embodiments, at step S602, the process 600 may include identifying, by calling the identifying module 414 (see FIG. 4) via the first API, the time series datasets, accessed from the database(s) 412, as training data to be utilized to model and train the generative model 407 as neural SDEs. In some embodiments, the SDEs may be a class of mathematical equations utilized for modeling continuous-time stochastic processes. An SDE is composed of two components: a drift function and a diffusion function. The drift function indicates how a trend of the time series datasets evolve with time, and the diffusion function indicates how a stochasticity or a variation of the time series datasets evolve with time If an SDE only contains a drift (diffusion term is 0), then it is referred to as an ordinary differential equation (ODE).

A general form of each SDE may include the following:

$$dX ( t ) = f ( t , X ( t ) ) dt + g ( t , X ( t ) ) dW ( t )$$

where, ƒ(t, X(t)) corresponds to the drift function and g (t, X(t)) corresponds to the diffusion function. W(t) corresponds to a Weiner process (Brownian motion). Drift component may be utilized to model the trend (deterministic) behavior of the stochastic process. Diffusion component may be utilized to model the noise (stochastic) behavior of the stochastic process. The Wiener process may implement continuous-time stochastic process with Gaussian distributed increments, i.e., W(t₂)−W(t₁)˜N(0, t₂−t₁). Non-overlapping increments are independent. In some embodiments, the drift and diffusion functions may pre-defined using simple parametric models. After estimating model parameters, time series may be generated as solutions to the SDE.

In some embodiments, the time series datasets may include both synthetic datasets and real-world datasets. Synthetic datasets are artificial datasets that mimics real-world datasets and may be created using algorithms or computer simulations. Real world datasets may be obtained from real world phenomena. For example, time series dataset corresponding to financial market in a real world phenomena may exhibit sharp distributional shifts due to exogenous factors (e.g., global financial crisis, the COVID-19 pandemic, etc.).

Change point detection may prove to be a critical aspect of time series analysis, especially in domains such as finance, climate science, and sensor data processing, where abrupt shifts in behavior may have profound implications. By identifying change points by the identifying module 414 as disclosed herein, may partition the time series datasets into distinct segments where each segment may be described by a different SDE model. This adaptation allows the TSMTM 406 disclosed herein to capture the specific characteristics and uncertainties within each segment, leading to a more precise understanding of the underlying processes.

For example, in some embodiments, at step S604, the process 600 may include partitioning, by calling the partitioning module 416 via the second API, the training data into a plurality of segments based on a sliding window approach. For example, a change point detection scheme for neural SDEs (trained as GANs) may be implemented by leveraging the learned GAN discriminator 409 as a means to approximate the Wasserstein distance between time series samples. Specifically, the partitioning module 416 may be configured to first partition the training data into multiple segments based on the sliding window approach disclosed herein and then input them sequentially into the GAN discriminator 409 to get a sequence of scores. The change point estimate may be then updated by specifying the change point of the score sequence, at which the approximated Wasserstein distance between two consecutive segments is the largest.

The effectiveness and versatility of this approach through extensive experiments on synthetic and real world datasets are described below with reference to FIGS. 4-6.

In some embodiments, the TSMTM 406 implements SDEs having the following form:

$${dX}_{t} = f ( t , {X}_{t} ) dt + g ( t , {X}_{t} ) ∘ {dW}_{t} , \qquad ( 1 )$$

where X₀˜μ is the initial state following the initial distribution μ, X={Xₜ}_{t∈[0,T]} is a continuous R^{x}-valued stochastic process, “º” denotes that the SDE is understood using Stratonovich integration, ƒ:[0,T]×R^{x}→R^{x} is called the drift function that describes the deterministic evolution of the stochastic process, g:[0,T]×R^{x}→R^{x×w} is called the diffusion function and W={Wₜ}_{t≥0} is a w-dimensional Brownian motion representing the random noise in the sample path. Unlike ODEs (ordinary differential equations), SDEs do not always have unique solutions. X={Xₜ}_{t≥0} may be a strong solution of the SDE (1) if it satisfies (1) for each sample path of the Wiener process {Wₜ}_{t≥0} to and for all t in the defined time interval almost surely.

Due to the large capacity of neural networks for function approximation, neural SDEs have been utilized by the TSMTM 406 which model the drift and diffusion terms via neural networks. When training the neural SDEs, the drift function ƒ and the diffusion function g are assumed to be Lipschitz continuous so that a unique strong solution to the SDEs exists. Therefore, when there are changes in the dynamics of the stochastic process, it is not accurate to model the stochastic process as a single neural SDE. Thus, the TSMTM 406 implements an algorithm that leverages multiple neural SDE models conditioned on change points to model the dynamics of a continuous-time stochastic process. Thus, the TSMTM 406 may jointly detect the change of the dynamics in the time series and model the time series with multiple SDEs conditioned on the change points.

Fitting the SDEs may be approached using Wasserstein GANs. WGANs utilize a generator network and a discriminator network, where the loss function is defined using the Wasserstein distance. WGANs enforce Lipschitz continuity on the discriminator through gradient penalties, fostering training stability and convergence while minimizing mode collapse.

Let Yₜᵣᵤₑ be the ground truth of the SDE trajectory which is a random variable on the path space. Let V˜N(0,Iᵥ) be a v-dimensional random Gaussian noise. The generator maps V to a trajectory, which is the solution to the following neural SDE:

$${X}_{0} = {ζ}_{θ} ( V ) , {dX}_{t} = {μ}_{θ} ( t , {X}_{t} ) dt + {σ}_{θ} ( t , {X}_{t} ) ∘ {dW}_{t} , {Y}_{t} = {α}_{θ} {X}_{t} + {β}_{θ} , \qquad ( 2 )$$

where ζ_{θ}, μ_{θ} and σ_{θ} are (Lipschitz) neural networks and are parameterized by θ. α_{θ} and β_{θ} are vectors that are jointly optimized. The generator networks are optimized so that the generated sample on path space Yris close to the ground truth trajectory Yₜᵣᵤₑ.

For the GAN discriminator 409 (see FIG. 4), a neural controlled differential equation (CDE) may be utilized since it may take an infinite-dimensional sample path as input and may output a scalar score, which in practice measures the realism of path with respect to the real data.

The GAN discriminator 409, in some embodiments may have the following form:

$${H}_{0} = {ξ}_{ϕ} ( {Y}_{0} ) , {dH}_{t} = {f}_{ϕ} ( t , {H}_{t} ) dt + {g}_{ϕ} ( t , {H}_{t} ) ∘ {dY}_{t} , D = {m}_{ϕ} \cdot {H}_{T} , \qquad ( 3 )$$

where ξ_{φ},ƒ_{φ} and g_{φ} are (Lipschitz) neural networks and are parameterized by φ, H:[0,T]→R^{h} is the solution to this SDE and m_{φ} maps the terminal state H_{T} to a scalar D.

Let Y_{θ}:(V, {W}_{t≥0})→Y be the overall action of the generator and D_{φ}:Y→D be the overall action of the discriminator. Let y be the collection of the training data. The training loss may be defined as the Wasserstein GANs, where the generator may be trained to minimize

$${E}_{V , W} [ {D}_{ϕ} ( {Y}_{θ} ( VW ) ) ] , \qquad ( 4 )$$

and the discriminator is trained to maximize

$${E}_{V , W} [ {D}_{ϕ} ( {Y}_{θ} ( V , W ) ) ] - {E}_{y} [ {D}_{ϕ} ( y \hat{} ) ] . \qquad ( 5 )$$

The goal is to minimize the Wasserstein distance between the true data distribution and the generated distribution. The loss functions may be optimized using various stochastic optimization techniques, e.g., Stochastic Gradient Descent (SGD), Root Mean Square Propagation (RMSprop), Adaptive Moment Estimation, etc., but the disclosure is not limited thereto.

SGD is an iterative method for optimizing an objective function with suitable smoothness properties. The SGD is an iterative optimization process that searches for an objective function's optimum value (Minimum/Maximum). It may be utilized for changing the generative model's 407 parameters in order to reduce a cost function in machine learning projects. The primary goal of the SGD is to identify the model parameters for the generative model 407 that provide the maximum accuracy on both training and test datasets. In SGD, the gradient is a vector pointing in the general direction of the function's steepest rise at a particular point. The algorithm might gradually drop towards lower values of the function by moving in the opposite direction of the gradient, until reaching the minimum of the function.

RMSprop is an optimization algorithm that uses gradients to train artificial neural networks (ANNs). RMSprop is a gradient descent algorithm that uses a moving average of squared gradients to scale the learning rate for each parameter. This helps to stabilize the learning process and prevent oscillations in the optimization trajectory.

Adaptive Moment Estimation is an algorithm for optimization technique for gradient descent. The method may prove to very efficient when working with large problem involving a lot of data or parameters as disclosed herein. It requires less memory and is efficient.

For example, at step S606, the process 600 implemented by the TSMTM 406 may include inputting by calling the inputting module 418 via the third API, the plurality of segments, generated at step S604, sequentially into the GAN discriminator 409 thereby transforming the GAN discriminator into a learned GAN discriminator.

At step S608, the process 600 implemented by the TSMTM 406 may include, generating, by utilizing the learned GAN discriminator 409 that calls the generating module 420 via the fourth API, a sequence of scores corresponding to the plurality of segments.

In some embodiments, at step S608, the process 600 implemented by the TSMTM 406 may include, defining, by calling the defining module 430 via the ninth API, an average mean of each segment among the plurality of segments over all training samples of the time series datasets; and detecting the change points utilizing the average mean.

In some embodiments, at step S608, the process 600 implemented by the TSMTM 406 may include, defining, by calling the defining module 430 via the ninth API, a maximum mean discrepancy based on quantifying the difference of scores between two consecutive segments among the plurality of segments; and detecting the change points utilizing the maximum mean discrepancy.

In some embodiments, at step S610, the process 600 implemented by the TSMTM 406 may include computing, by utilizing the learned GAN discriminator 409 that calls the computing module 422 via the fifth API, a Wasserstein distance between two consecutive segments among the plurality of segments. At step S612, the process 600 implemented by the TSMTM 406 may include detecting, by calling the detecting module 424 via the sixth API, change points based on output of the learned GAN discriminator 409 by specifying corresponding change point with reference to difference of scores between two consecutive segments at which the computed Wasserstein distance between the two consecutive segments is the largest. At step S614, the process 600 implemented by the TSMTM 406 may include modeling, by calling the modeling module 426 via the seventh API, the neural SDEs with the detected change points.

The process 600 implemented by the TSMTM 406 is described below with further details using Wasserstein two-sample testing and training.

For example, in training the neural SDEs as GANs, at step S616 of the process 600 may include training, by calling the training module 428 via the eighth API, by alternating between detecting the change points while holding model parameters of the neural SDEs fixed and generating parameters of the GAN while holding the detected change points fixed (see, e.g., algorithm 500 as illustrated in FIG. 5). The training loss may be viewed as the Wasserstein distance between the training samples and the generated samples. Therefore, the learned model may be used to approximate the Wasserstein distance between two time series. A brief introduction for the Wasserstein two-sample test is described below with details of algorithm 500 in the following sections.

The Wasserstein two-sample test is a statistical method used to compare two sets of data and determine if they originate from the same distribution. Unlike traditional tests that focus on comparing means or variances, the Wasserstein two-sample test computes the Wasserstein distance between the empirical distributions of the samples which measures the minimum amount of cost required to transform one distribution into the other. Specifically, given independent and identically distributed (i.i.d.) samples X₁, . . . , Xₘ˜P and Y₁, . . . , Yₙ˜Q where P, Q are probability measures on R^{d}, let Pₘ, Qₙ denote the empirical distributions of X₁, . . . , Xₘ and Y₁, . . . , Yₙ respectively. Given an exponent p≥1, the p-Wasserstein distance between Pₘ and Qₙ is defined as

$$W ( {P}_{m} , {Q}_{n} ) = {( {inf}_{π ∈ \prod ( {P}_{m} , {Q}_{n} )} {\int }_{{ℝ}^{d} \times {ℝ}^{d}} {‖ X - Y ‖}^{p} d π )}^{\frac{1}{p}} ,$$

where Π(Pₘ, Qₙ) is the collection of all joint probability distribution on R^{d}×R^{d} with marginal distribution Pₘ, Qₙ.

The Wasserstein two-sample test is particularly useful for high-dimensional data and may provide more informative insights into the dissimilarities between distributions. The Wasserstein distance has also found other applications in various aspects of statistical inference such as goodness-of-fit testing, and change detection. In change detection, Wasserstein barycenters may be utilized to capture changes in distribution.

In some embodiments, in detecting change points at step S612 of the process 600, the TSMTM 406 may utilize modeling change points in neural SDE models based on the GAN framework. To make the presentation more concise, consider the case where there is one change point and later discuss a straightforward extension to case of multiple change points. Note that since the detecting module 424 detects the change point and learn the SDE models in a data-driven manner and the data is not independent over time, it may prove to be challenging to directly detect the change using classical change detection algorithms such as the cumulative sum control algorithm. Observe that the training loss in equation (5) mentioned earlier may be defined to approximate the Wasserstein distance between the training data and the generated samples, given the trained discriminator (i.e., the GAN discriminator 409 as illustrated in FIG. 4), the TSMTM 406 may approximate the Wasserstein distance between two time series. Therefore, in some embodiments, TSMTM 406 leverages the Wasserstein two-sample test algorithm to detect change points and alternatively update the parameters for the SDEs and change point estimate.

The training algorithm implemented at step S616 of the process 600 may be summarized as follows. First, the training module 428 (see FIG. 4) may initialize the change point estimate v and the neural network parameters θ₀, θ₁, φ for the generating module 420 and the GAN discriminator 409. Second, based on the change point estimate v, the partitioning module 416 may partition the training data and run different SDE models for each segment and update the parameters of the GANs. Third, the implementing module 432, implements, via calling the tenth API, a sliding window algorithm to get multiple segments of the training data and then input them sequentially into the GAN discriminator 409. As the TSMTM 406 iterates through the time series datasets, a sequence of scores is returned. The difference of scores between two segments may be viewed as the Wasserstein distance between two segments. Therefore, the change point estimate may be then updated by specifying the change point of the score sequence.

FIG. 5 illustrates an algorithm 500 that summarizes the training algorithm. For example, the trained GAN discriminator 509 may receive training data 501 and output scores 503. At process 505, the TSMTM 406 updates SDE model parameters given the change point estimate. At process 507, the TSMTM 406 may detect the change based on the changes of scores. As the TSMTM 406 iterates processes 505 and 507 through the time series datasets, a sequence of scores is returned. For example, in detecting the change points, at step S612 of the process 600 implemented by the TSMTM 406 may include, implementing, by calling the implementing module 432 via the tenth API, the algorithm 500 that iteratively computes a statistic on the difference of scores between the two consecutive segments in the time series datasets, wherein a relatively large changes in the statistic beyond a configurable threshold value indicates a change point.

For example, for model parameters update, based on the change point estimate v (mentioned earlier), the TSMTM 406 may utilize sample paths X_{1:v-1} as training samples to optimize the parameter θ₀ of the neural SDE (before the change happens):

$${dX}_{t} = {μ}_{θ 0} ( t , {X}_{t} ) dt + {σ}_{θ0} ( t , {X}_{t} ) ∘ {dW}_{t} , \qquad ( 6 )$$

and use sample paths X_{v:T} as training samples to optimize the parameters θ₁ of the neural SDE (after the change happens):

$${dX}_{t} = {μ}_{θ 1} ( t , {X}_{t} ) dt + {σ}_{θ 1} ( t , {X}_{t} ) ∘ {dW}_{t} . \qquad ( 7 )$$

In some embodiments the TSMTM 406 may also be configured to update the parameter φ of the discriminator Da based on the generated trajectory Y_{1:T}.

For change point update, after the SDEs model parameters are updated, the TSMTM 406 may be configured to update the change point estimate. Consider a sliding window of size w. Note that this window size is a hyperparameter of the algorithm that can be tuned in practice. The TSMTM 406 may call the partitioning module 416 via the second API to partition the observed sample path into different segments X_{1:w}, X_{2:w+1}, . . . , X_{T-w+1:T}. Then pass each segment X_{t:t+w} into the GAN discriminator 409 and denote the returned score by sₜ:

$${s}_{t} = {D}_{ϕ} ( {X}_{t : t + w} ) , t = 1 , 2 , … , T - w + 1. \qquad ( 8 )$$

The subsequences X_{1:w}, X_{2:w+1}, . . . , X_{T-w+1:T} are thus converted to a sequence of scores s₁, s₂, . . . , s_{T-w+1}. The defining module 430 may define the average score over all training samples using the arithmetic average:

$${\overline{s}}_{t} = \frac{1}{N} {\sum }_{i = 1}^{N} {D}_{ϕ} ( {X}_{t : t + w}^{( i )} ) . \qquad ( 9 )$$

The difference between two average scores may be viewed as the Wasserstein distance between two corresponding segments. Sequentially, at each time t, the TSMTM 406 may be configured to compare the approximated Wasserstein distance between two consecutive segments s ₜ-s ₜ₋₁ with a pre-specified threshold γ to distinguish between two hypotheses: H₀: the change happens at time t; and H₁: the change happens after time t. When s ₜ-s ₜ₋₁>γ, the TSMTM 406 may declare that the change happens at time t, otherwise, the process proceeds to the next time Algorithm 1 neural SDEs with change points as follows:

```
$Require : Initial parameters {θ}_{0} , {θ}_{1} , ϕ , v , training samples {X}_{1 : T}^{1} , … , {X}_{1 : T}^{N} .$
while not converged do
  Update θ₀,θ₁,φ by running SGDbased on v.
  Compute s⁻t using (9) based on current φ Update v according to (10).
end while
```

In an offline setting, the change point may be estimated as the time index v where the changes of the average score is the largest:

$$v = {arg max}_{t} ( {\overline{s}}_{t} - {\overline{s}}_{t - 1} ) . \qquad ( 10 )$$

After the change point is updated, the TSMTM 406 may return again update the SDE model parameters and then the change point estimate again and repeat this process until convergence. A summary of algorithm by pseudocode in Algorithm 1 is mentioned earlier.

For extension to multiple change points, the algorithm may be easily adapted to the cases where there are multiple changes. Assume that there is only one change within a window with size w. The TSMTM 406 may sort all sₜ-sₜ₋₁ in descending order and denote their time index as v\hat{ }₁, v\hat{ }₂, . . . . The change point is first declared as v\hat{ }₁. If |v\hat{ }₂-v\hat{ }₁≤w, we discard v\hat{ }₂ and proceed to the following element until we find the i such that |v\hat{ }ᵢ-v\hat{ }₁|>w. Then, v\hat{ }ᵢ represents another change point. More change points may be found by repeating this process.

In simulating results, the TSMTM 406 may implement an Ornstein-Uhlenbeck (OU) process, which may be defined by the following SDE:

$${dX}_{t} = ( μ t - θ {X}_{t} ) dt + σ ∘ {dW}_{t} . \qquad ( 11 )$$

The TSMTM 406 may utilize the cases where there is one change point, two change points and three change points. Let the change points be v₁=32, v₂=64, v₃=96. Before v₁, we set μ₁=0.04, θ₁=0.1, θ₁=0.4. After v₁ and before v₂, we set μ₂=−0.02, θ₂=0.1, θ₂=0.4. After v₂ and before v₃, we set μ₃=0.02, θ₃=0.1, θ₃=0.4. After v₄, we set μ₄=−0.02, θ₄=0.1, θ₄=0.4. Baselines: the TSMTM 406 may compare the algorithm disclosed above with two heuristic change detection approaches. The first one detects the change by the mean change of the time series discussed earlier. Specifically, the partitioning module 416 may partition the sample into different segments X_{1:w}, X_{2:w+1}, . . . , X_{T-w+1:T}. Define the average mean of each segment over all training samples as

$${\overline{μ}}_{t} = \frac{1}{N} {\sum }_{i = 1}^{N} {\sum }_{t = 1}^{w} {X}_{t}^{( i )} . \qquad ( 12 )$$

The change point using the average mean is then estimated as v\hat{ }ₘₑₐₙ=argmaxₜ( μₜ−μ ₜ₋₁). The second approach is based on the maximum mean discrepancy (MMD) which is usually used to quantify the difference between two distributions. Define the average MMD between two consecutive segments as

$${\overline{η}}_{t} = \frac{1}{N} {\sum }_{i = 1}^{N} MMD ( {X}_{t - 1 : t + w - 1}^{i} , {X}_{t : t + w}^{i} ) . \qquad ( 13 )$$

The change point using the average MMD is then defined as v\hat{ }_{MMD}=argmaxₜ η ₜ.

The GUI 436 (see FIG. 4) may be utilized by the TSMTM 406 to display the results.

In some embodiments, the real world datasets may include Exchange-Traded Fund (ETF) data from Dec. 12, 2019 to Jun. 7, 2020 which covers the COVID period where a sharp distributional shift occurred, but the disclosure is not limited thereto. Each sample of the data corresponds to have a different underlier of the S&P 500 index, but the disclosure is not limited thereto. The data may be normalized to have mean zero and unit variance. Any other data that may show distributional shifts, i.e., in climate science, and sensor data processing, where abrupt shifts in behavior may have profound implications, may also be utilized by the TSMTM 406 in consistent with the processes disclosed herein.

The algorithm implemented by the TSMTM 406 disclosed herein results in the advancement of more robust and accurate modeling techniques in terms of generative quality on datasets exhibiting distributional shifts, particularly in the context of, e.g., financial markets, climate science, and sensor data processing, etc., where the ability to capture dynamic changes is crucial for informed decision-making, but the disclosure is not limited thereto.

In some embodiments, the TSMTD 402 may include a memory (e.g., a memory 106 as illustrated in FIG. 1) which may be a non-transitory computer readable medium that may be configured to store instructions for implementing a platform, language, database, and cloud agnostic TSMTM 406 for modeling and training a generative model for time series datasets that may include both synthetic data and real world data as disclosed herein. The TSMTD 402 may also include a medium reader (e.g., a medium reader 112 as illustrated in FIG. 1) which may be configured to read any one or more sets of instructions, e.g., software, from any of the memories described herein. The instructions, when executed by a processor embedded within the TSMTM 406 or within the TSMTD 402, may be used to perform one or more of the processes as described herein. In a particular embodiment, the instructions may reside completely, or at least partially, within the memory 106, the medium reader 112, and/or the processor 104 (see FIG. 1) during execution by the TSMTD 402.

In some embodiments, the instructions, when executed, may cause a processor embedded within the TSMTM 406 or the TSMTD 402 to perform the following: identifying the time series datasets, accessed from a database by calling an application programming interface, as training data to be utilized to model and train the generative model as neural SDEs; partitioning the training data into a plurality of segments based on a sliding window approach; inputting the plurality of segments sequentially into a GAN discriminator thereby transforming the GAN discriminator into a learned GAN discriminator; generating, by utilizing the learned GAN discriminator, a sequence of scores corresponding to the plurality of segments; computing, by utilizing the learned GAN discriminator, a Wasserstein distance between two consecutive segments among the plurality of segments; detecting change points based on output of the learned GAN discriminator by specifying corresponding change point with reference to difference of scores between two consecutive segments at which the computed Wasserstein distance between the two consecutive segments is the largest; modeling the neural SDEs with the detected change points; and training the neural SDEs by alternating between detecting the change points while holding model parameters of the neural SDEs fixed and generating parameters of the GAN while holding the detected change points fixed thereby improving performance of the generative model, but the disclosure is not limited thereto. For example, the features values may represent other data as disclosed above. In some embodiments, the processor may be the same or similar to the processor 104 as illustrated in FIG. 1 or the processor embedded within the TSMTD 202, TSMTD 302, TSMTD 402, and TSMTM 406 which may be the same or similar to the processor 104.

In some embodiments according to the non-transitory computer readable medium, the time series datasets may include both synthetic datasets and real-world datasets.

In some embodiments, the instructions, when executed, may cause the processor 104 to further perform the following: defining an average mean of each segment among the plurality of segments over all training samples of the time series datasets; and detecting the change points utilizing the average mean.

In some embodiments, the instructions, when executed, may cause the processor 104 to further perform the following: defining a maximum mean discrepancy based on quantifying the difference of scores between two consecutive segments among the plurality of segments; and detecting the change points utilizing the maximum mean discrepancy.

In some embodiments according to the non-transitory computer readable medium, the SDEs may be a class of mathematical equations utilized for modeling continuous-time stochastic processes.

In some embodiments according to the non-transitory computer readable medium, each SDE may be composed of two components: a drift function and a diffusion function. The drift function may indicate how a trend of the time series datasets evolve with time, and the diffusion function may indicate how a stochasticity or a variation of the time series datasets evolve with time, but the disclosure is not limited thereto.

In some embodiments, in detecting the change points, the instructions, when executed, may cause the processor 104 to further perform the following: implementing an algorithm that iteratively computes a statistic on the difference of scores between the two consecutive segments in the time series datasets, wherein a relatively large changes in the statistic beyond a configurable threshold value indicates a change point.

In some embodiments as disclosed above in FIGS. 1-6, technical improvements effected by the instant disclosure may include a platform for implementing a platform, language, database, and cloud agnostic time series modeling and training module configured to model and train a deep generative model for time series with change points using GAN-based neural SDEs, thereby substantially improving performance of the deep generative model, but the disclosure is not limited thereto. By identifying change points, the time series modeling and training module disclosed herein with respect to FIGS. 1-6 may be configured to partition the time series into distinct segments where each segment is described by a different SDE model. This adaptation allows the time series modeling and training module to capture the specific characteristics and uncertainties within each segment, leading to a more precise understanding of the underlying processes and improved performance of the generative model, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for modeling and training a generative model for time series datasets by utilizing one or more processors along with allocated memory, the method comprising:
identifying the time series datasets, accessed from a database by calling an application programming interface, as training data to be utilized to model and train the generative model as neural stochastic differential equations (SDEs);
partitioning the training data into a plurality of segments based on a sliding window approach;
inputting the plurality of segments sequentially into a generative adversarial network (GAN) discriminator thereby transforming the GAN discriminator into a learned GAN discriminator;
generating, by utilizing the learned GAN discriminator, a sequence of scores corresponding to the plurality of segments;
computing, by utilizing the learned GAN discriminator, a Wasserstein distance between two consecutive segments among the plurality of segments;
detecting change points based on output of the learned GAN discriminator by specifying corresponding change point with reference to difference of scores between two consecutive segments at which the computed Wasserstein distance between the two consecutive segments is the largest;
modeling the neural SDEs with the detected change points; and
training the neural SDEs by alternating between detecting the change points while holding model parameters of the neural SDEs fixed and generating parameters of the GAN while holding the detected change points fixed thereby improving performance of the generative model.

2. The method of claim 1, wherein the time series datasets include both synthetic datasets and real-world datasets.

3. The method of claim 2, further comprising:
defining an average mean of each segment among the plurality of segments over all training samples of the time series datasets; and
detecting the change points utilizing the average mean.

4. The method of claim 2, further comprising:
defining a maximum mean discrepancy based on quantifying the difference of scores between two consecutive segments among the plurality of segments; and
detecting the change points utilizing the maximum mean discrepancy.

5. The method of claim 1, wherein the SDEs are a class of mathematical equations utilized for modeling continuous-time stochastic processes.

6. The method of claim 5, wherein each SDE is composed of two components: a drift function and a diffusion function, wherein the drift function indicates how a trend of the time series datasets evolve with time, and wherein the diffusion function indicates how a stochasticity or a variation of the time series datasets evolve with time.

7. The method of claim 6, wherein in detecting the change points, the method further comprising:
implementing an algorithm that iteratively computes a statistic on the difference of scores between the two consecutive segments in the time series datasets,
wherein a relatively large changes in the statistic beyond a configurable threshold value indicates a change point.

8. A system for modeling and training a generative model for time series datasets the system comprising:
a processor; and
a memory operatively connected to the processor via a communication interface, the memory storing computer readable instructions, when executed, causes the processor to:
identify the time series datasets, accessed from a database by calling an application programming interface, as training data to be utilized to model and train the generative model as neural stochastic differential equations (SDEs);
partition the training data into a plurality of segments based on a sliding window approach;
input the plurality of segments sequentially into a generative adversarial network (GAN) discriminator thereby transforming the GAN discriminator into a learned GAN discriminator;
generate, by utilizing the learned GAN discriminator, a sequence of scores corresponding to the plurality of segments;
compute, by utilizing the learned GAN discriminator, a Wasserstein distance between two consecutive segments among the plurality of segments;
detect change points based on output of the learned GAN discriminator by specifying corresponding change point with reference to difference of scores between two consecutive segments at which the computed Wasserstein distance between the two consecutive segments is the largest;
model the neural SDEs with the detected change points; and
train the neural SDEs by alternating between detecting the change points while holding model parameters of the neural SDEs fixed and generating parameters of the GAN while holding the detected change points fixed thereby improving performance of the generative model.

9. The system of claim 8, wherein the time series datasets include both synthetic datasets and real-world datasets.

10. The system of claim 9, wherein the processor is configured to:
define an average mean of each segment among the plurality of segments over all training samples of the time series datasets; and
detect the change points utilizing the average mean.

11. The system of claim 9, wherein the processor is configured to:
define a maximum mean discrepancy based on quantifying the difference of scores between two consecutive segments among the plurality of segments; and
detect the change points utilizing the maximum mean discrepancy.

12. The system of claim 8, wherein the SDEs are a class of mathematical equations utilized for modeling continuous-time stochastic processes.

13. The system of claim 12, wherein each SDE is composed of two components: a drift function and a diffusion function, wherein the drift function indicates how a trend of the time series datasets evolve with time, and wherein the diffusion function indicates how a stochasticity or a variation of the time series datasets evolve with time.

14. The system of claim 13, wherein in detecting the change points, the processor is further configured to:
implement an algorithm that iteratively computes a statistic on the difference of scores between the two consecutive segments in the time series datasets,
wherein a relatively large changes in the statistic beyond a configurable threshold value indicates a change point.

15. A non-transitory computer readable medium configured to store instructions for modeling and training a generative model for time series datasets, the instructions, when executed, cause a processor to perform the following:
identifying the time series datasets, accessed from a database by calling an application programming interface, as training data to be utilized to model and train the generative model as neural stochastic differential equations (SDEs);
partitioning the training data into a plurality of segments based on a sliding window approach;
inputting the plurality of segments sequentially into a generative adversarial network (GAN) discriminator thereby transforming the GAN discriminator into a learned GAN discriminator;
generating, by utilizing the learned GAN discriminator, a sequence of scores corresponding to the plurality of segments;
computing, by utilizing the learned GAN discriminator, a Wasserstein distance between two consecutive segments among the plurality of segments;
detecting change points based on output of the learned GAN discriminator by specifying corresponding change point with reference to difference of scores between two consecutive segments at which the computed Wasserstein distance between the two consecutive segments is the largest;
modeling the neural SDEs with the detected change points; and
training the neural SDEs by alternating between detecting the change points while holding model parameters of the neural SDEs fixed and generating parameters of the GAN while holding the detected change points fixed thereby improving performance of the generative model.

16. The non-transitory computer readable medium of claim 15, wherein the time series datasets include both synthetic datasets and real-world datasets.

17. The non-transitory computer readable medium of claim 16, wherein the instructions, when executed, cause the processor to further perform the following:
defining an average mean of each segment among the plurality of segments over all training samples of the time series datasets; and
detecting the change points utilizing the average mean.

18. The non-transitory computer readable medium of claim 16, wherein the instructions, when executed, cause the processor to further perform the following:
defining a maximum mean discrepancy based on quantifying the difference of scores between two consecutive segments among the plurality of segments; and
detecting the change points utilizing the maximum mean discrepancy.

19. The non-transitory computer readable medium of claim 15, wherein the SDEs are a class of mathematical equations utilized for modeling continuous-time stochastic processes, wherein each SDE is composed of two components: a drift function and a diffusion function, wherein the drift function indicates how a trend of the time series datasets evolve with time, and wherein the diffusion function indicates how a stochasticity or a variation of the time series datasets evolve with time.

20. The non-transitory computer readable medium of claim 19, wherein in detecting the change points, wherein the instructions, when executed, cause the processor to further perform the following:
implementing an algorithm that iteratively computes a statistic on the difference of scores between the two consecutive segments in the time series datasets,
wherein a relatively large changes in the statistic beyond a configurable threshold value indicates a change point.
